(19) United States
(12) Patent Application Publication
(10) Pub. No.: US 2009/0235582 A1
(43) Pub. Date: Sep. 24, 2009

(54) CHRISTMAS TREE PLATFORM

(76) Inventor: John Samuel Kidwell, Mount Airy, NC (US)

Correspondence Address: PASSE' INTELLECTUAL PROPERTY, LLC, 1717 BRASSFIELD RD., RALEIGH, NC, 27614, US

(21) Appl. No.: 12/052,312

(22) Filed: Mar. 20, 2008

(51) Int. Cl. A01G 17/10

(52) U.S. Cl. 47/43

(57) ABSTRACT

The present invention relates to a Christmas tree platform for mounting a full-sized Christmas tree in a Christmas tree stand. The platform has wheels, can fold in half and forms a storage compartment when folded in half. The storage compartment is capable of holding removable decorations on the platform. In one embodiment of the invention there is a means for mounting a Christmas tree stand in a fixed position on the platform.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a support means for Christmas trees. In particular, it relates to a Christmas tree platform that is easy to store, move about with a fully loaded Christmas tree and store the platform decorations within the storage form of the platform.

2. Description of Related Art

Full sized Christmas trees are frequently placed in a Christmas tree stand then positioned up against a wall or other backdrop. Accordingly, decorating the Christmas tree can be difficult on the reverse side as can the hanging and maintaining of the lighting for the tree. Platforms with a Christmas tree stand for placing a Christmas tree have been used but they suffer from being difficult to position with the fully loaded Christmas tree, are difficult to store because of size necessary to support a full-sized Christmas tree and frequently the decorative part of the platform is easily broken or damaged because of its fragile but unprotected and often permanent positioning on the platform. Christmas decorative items and items related to Christmas trees are often stored between uses in attics whose entrance is often of the pull down stair variety or frequently through narrow entrance ways. Accordingly, large items such as the big platform necessary to support a Christmas tree are unwieldy and in some situations incapable of being stored in the attic. A further problem with platforms are that the heavy weight of the Christmas tree with ornaments, water and the like over time causes the platform to begin to sag in the center. Many Christmas tree stand's designs are available but they are difficult to reposition like the platforms, and they keep the tree positioned close to or against the ground that poses its own set of problems, especially with small children or animals. Further, a stand by itself makes ornamentation on the floor difficult as the ornamentation will interfere with the placement of Christmas presents on Christmas day.

Yet another problem with the existing solutions is that most people already own their favorite Christmas tree stand that possess qualities desired for their particular situations. The present platforms with built-in stands require that the built-in stand be used, and based on the designs shown in the issued patents, limit the user to much less function in a tree stand than available in the better available tree stands.

In Design U.S. Pat. No. 381,930 to Faller and U.S. Pat. No. 389,777 to Altieri there is disclosed a Christmas tree platform with built-in tree stand. They both have decorative perimeters; however, the platform is large, unmovable and the decorations remain in fragile position exposed on the top of the platform. In U.S. Pat. No. 5,213,407 there is disclosed a Christmas tree platform designed for miniature Christmas trees. It is also designed to be stationary; however, due to its small size, it is easy to store. This particular platform has no ornamental additions but does have lighting. The unit is not designed for a full-sized Christmas tree and larger versions of this design would possess the same problems as other known platforms.

Despite the fact that these problems with Christmas trees have been around for decades in some instances without a solution, it would be useful if there were a means or a platform that overcame the problems and limitations of the current available choices for Christmas trees.

### SUMMARY OF THE INVENTION

It has been discovered that the problems and limitations of the prior art can be overcome with the present invention. By including a folding means in the platform along with storage, wheels and in some instances central support, a platform for full-sized Christmas trees can be built which overcomes those limitations.

Accordingly, one embodiment of the present invention is a platform for the placement of a full-sized Christmas tree in a tree stand comprising:
a) a platform surface having a perimeter and an upper and lower surface sufficient to place the tree;
b) an edging material defining the perimeter of the platform surface;
c) a plurality of wheels positioned on the platform lower surface;
d) a folding means for folding the platform in half;
e) one or more removably positioned ornamental structures, positioned on the platform surface upper surface; and
wherein the platform forms a storage compartment when folded in half.

In another embodiment of the present invention there is a Christmas tree platform comprising wheels and a means for supporting the center of the platform when a Christmas tree is placed thereon.

In another embodiment of the invention there is a Christmas tree platform with a means of attaching a Christmas tree stand on an upper surface of the platform.

### BRIEF DESCRIPTION OF THE DRAWINGS

FIG. 1 is a perspective of an embodiment of the present invention showing a Christmas tree stand attachment means.

FIG. 2 is a bottom perspective of the platform of the present invention showing embodiments of the storage means and the central support means.

FIG. 3 is a side perspective of the platform of the present invention with the decorative pieces stored and the platform in the process of being folded to the closed position.

FIG. 4 is an embodiment of the invention with a Christmas tree stand with Christmas tree mounted to it and the ornaments of the platform removed for attachment clarity.

### DETAILED DESCRIPTION OF THE INVENTION

The present invention relates to a full sized Christmas tree platform for holding a Christmas tree stand and Christmas tree. It includes a means for folding the platform, storage space for the platform ornaments, as well as a means for attaching a Christmas tree stand and central support means. The present invention overcomes the limitations and problems of the prior art by folding small enough to be easily stored and providing a storage means for holding the platform ornaments.

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one as or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “and an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

As used herein “full-sized Christmas tree” refers to a real or artificial Christmas tree that is from about 2 or 3 feet up to the tallest size available of Christmas trees. In general they will be up to about 15 feet but larger sizes could be accommodated. Below that size of Christmas tree would be considered miniature Christmas tree. A “platform” for the placement of a tree refers to a flat, raised surface for placing a full-sized Christmas tree in its stand on, thus elevating the tree above the floor.

The platform also has decorations on it, for example, fencing or miniature stairs from the ground to the platform. Other types of decorations could be used but in common in the present invention they are removably attached to the platform. The decorations can thus be fixed in place and not move or fall during the platforms use and can after use be removed and placed in the present invention storage means. The decorations can be removably attached by having them press fit in a slot, use of Velcro ties or the like.

The size of the platform is in general larger than the base of the tree or the tree stand. So, for example, it can be approximately 2 feet to about 4 feet across but can be dictated by either convenience or size of the tree. The shape of the base is in one embodiment rectangular or square but other shapes could be formed as desired, for example, round, oval or the like. In general, the platform flat surface has an upper and lower surface, for example, when formed by a piece of plywood. The platform shape and size has a given perimeter which is designed in consideration of the tree size, the tree stand and the like, as described above. Thus, by selecting the appropriate size and shape, it will be sufficiently large for placement of a Christmas tree in a Christmas tree stand.

The platform surface will have edging around the perimeter of the surface. In general edging will be from about 2 to 4 inches or the like. The edging can be of a design or simple carpentry edging. The edging enables the platform to form an enclosure when folded and thus present the user with a storage area for containing the removable decorations.

The present invention Christmas tree platform further comprises a set of wheels for moving the platform about during use. Between about 3 and 5 wheels would be optimum but the final amount of wheels would be determined by the final size of the platform and tree to be supported. The exact number is within the skill in the art in view of the present disclosure. In one embodiment, there are one or more wheels positioned toward or at the center of the lower surface of the platform. By positioning one or more wheels there, they act as a platform support to prevent the platform from sagging under the weight of the tree.

As used herein “folding means” refers to the addition of hinges or the like in order to essentially fold the platform in half. By folding the platform in half, along with the edging described above, the folded platform creates a closed box which can be used for storage of the decorations or other Christmas-related items, if there is extra room. Accordingly, symmetrical shapes are most advantageous for the practice of the present invention so that halves would meet upon folding in half. The folding means as described could be hinges of the metal type; however, any kind of folding means could be employed that achieved the folding desired of the present invention closed position of the platform. In order to have something to mount the hinge means, the equator line that the platform will fold along can be built with cross beams such that each half of the hinge can be mounted to the cross beams. This embodiment also strengthens the center of the platform and like the 5^{th} wheel under the center helps prevent the sag of the platform problem experienced with prior art platforms.

The storage means as described is formed by the bottom or lower portion of the platform as it folds and meets the edging of the platform and forms an enclosure. The decorations of the present invention are designed to be removable and sized to fit within the enclosure. In one embodiment, there are straps, snaps, Velcro, tie-downs or other attachment means mounted on the lower surface of the platform sufficient to restrict the movement of ornaments placed in the enclosure area. In addition, in one embodiment, there are one or more enclosures mounted on the lower surface within the main enclosure for containing smaller or fragile pieces or the like in a situation where it would be preferable to have such containers compared with the other suggested attachment means.

As used herein “a means for attaching a Christmas tree stand” refers to an attachment means whereby a Christmas tree stand can be fixed in place on the platform such that when a tree is placed in the stand, the tree in the stand will stay positioned in the same place. This is especially important when the platform is being rolled about for decorating. Once positioned and even partially decorated it is not desirable to have to re-center or reposition the Christmas tree stand on the platform. The attachment means can be simple or more complex as desired. In one embodiment the means is a tie-down, Velcro or the like. In another embodiment it uses one or more clamps, latches, indents or the like for fixing the stand in place. In one embodiment the stand could be permanently attached to the platform, and in another embodiment the stand is removable.

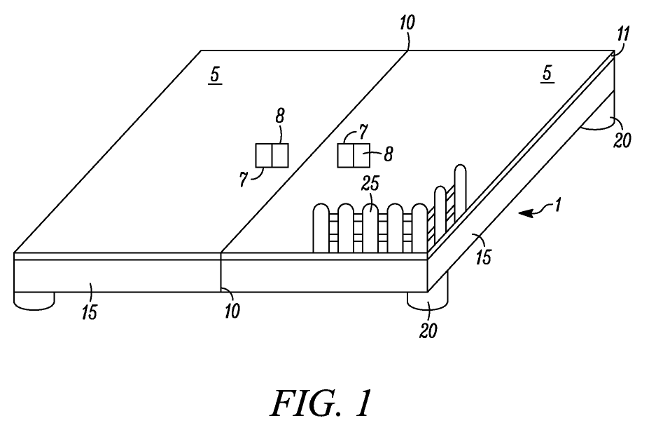

Now referring to the drawings, FIG. 1 is a perspective view of an embodiment of a Christmas tree platform 1 of the present invention. In this view we see the platform upper surface 5. On the upper surface 5 is shown Christmas tree stand holders 7. In this view there are indentations for holding the stand along with Velcro hook and loop fasteners 8 for holding the stand. Obviously, other forms of holders could be designed within the teaching of the present invention. In the middle of the upper surface 5 is the split line 10, the dividing line for the platform where the platform 1 may be folded in half. The hinging means is not seen in this view since hinging is below the level of the upper surface 5. In this view one can see a platform top thickness 11 is fairly narrow, for example, by use of plywood for the surface. (Although any material such as plastic could be used.)

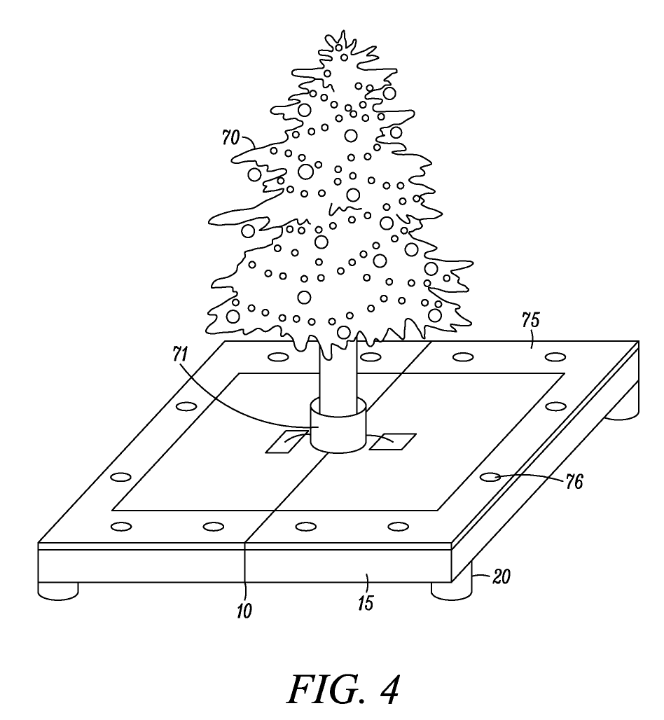

One can see in this view the edging 15 is shown which forms the storage compartment sides when the platform 1 is folded along line 10. While the edging can reach almost to the floor in this view, the edging is shown short so one can see the wheels 20. The wheels are mounted offset in order to not hit one another when the platform 1 is closed. Other means of keeping the wheels from hitting could also be used such as making the wheels removable. An important feature of the present invention is removably mounted decoration 25, in this embodiment, perimeter fencing. The decorations 25 are set in peg and slot means but any removable mounting means could be used. The peg holes are seen in the view shown in FIG. 4. Pegs on the bottom of fencing decorations 25 are not shown but within the skill in the art.

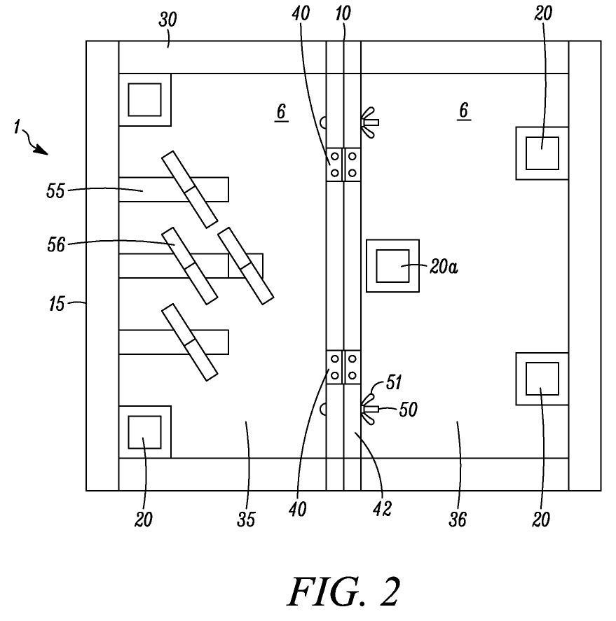

In FIG. 2 we see a bottom view of platform 1. In the view of FIG. 2 we see bottom surface 6. Here we can see wheels 20, with four at the individual corners. Wheel 20a, however, is roughly towards the middle of platform 1. By placing a wheel at the center of the platform 1 it acts to support the upper surface 5 from sagging under weight of a Christmas tree. While one offset wheel 20a is shown, one could mount a pair of wheels or as many as necessary to support a tree. More wheels might be necessary to support a very large tree.

The edging 15 in this embodiment of platform 1 is essentially two by fours mounted below the platform 1 and having a thickness 30 of the edging can be seen in this view. The edging 15 creates a left 35 and right 36 compartment which when the platform is folded creates a storage compartment for storing decorations 25 or anything that the user desires to store for Christmas. An embodiment of smaller compartments, as described above, could also be mounted underneath platform 1. The platform 1 folds along line 10 as mentioned above, but in this view, we can see hinges 40 which allow the platform 1 to fold in half. In this embodiment there are hinge beams 42 which are used to mount hinges 40. In this particular embodiment, there are bolt 50 and wing nut 51 which are mounted through hinge beams 42. This nut and bolt combination locks the platform in the open position so that the platform 1 will not accidently close during use prior to a desired time.

In left compartment 35 there are storage mounting strips 55 and tie downs 56. The mounting strips 55 are short wooden strips to give something to mount the tie downs 56 to. The decorations 25 can be broken down into pieces that fit in the compartments and be tied down in place to keep them from moving. Alternatively smaller compartments could be mounted into the larger compartment. Velcro strips or other means could also be used to hold the decorations 25 in place.

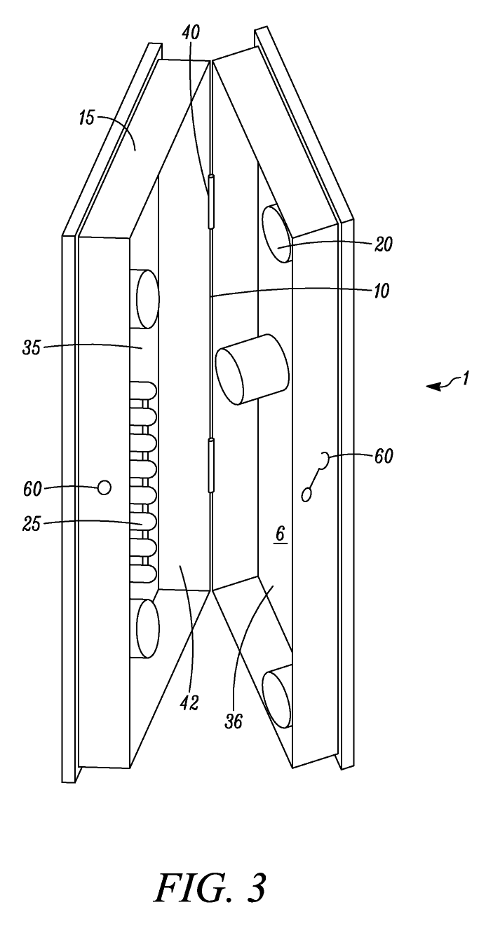

In FIG. 3 there is a view of platform 1 that is in the process of being folded alone line 10 using hinges 40. In this view the decorations 25 have been removed and placed, after being broken down into pieces, into left compartment 35 for storage when the platform 1 is completely closed. In this view we can see hook and button 60 which is used to lock the device in the closed position when the two halves meet.

In FIG. 4 we see a perspective view of the platform 1 with the decorations removed and Christmas tree 70 and tree stand 71 mounted to the platform 1 using mounting means 7. The tree is shown small for purposes of the drawings but obviously would be a full sized tree as described above. One can see an embodiment wherein perimeter top edging 75 has been added where the decorations 25 are mounted. Since decorations 25 are removed, we see peg holes 76 used for mounting the decorations 25. The decorations can thus be press fit into the peg holes 76 during use.

The drawings and examples herein are not intended to be limiting. Changes in materials size, hinge means, tree stand holding means and the like can be modified or substituted in light of the teaching herein, and the claims which follows are to be so interpreted.

1. A platform for the placement of a full-sized Christmas tree in a tree stand comprising:
a) a platform surface positioned close to the ground having a perimeter and an upper and lower surface sufficient to place the tree;
b) an edging material defining the perimeter of the platform surface;
c) a plurality of wheels positioned directly on the platform lower surface;
d) a folding means for folding the platform in half;
e) one or more removably positioned ornamental structures, positioned on the platform surface upper surface; and
wherein the platform forms a storage compartment when folded in half.

2. A platform according to claim 1 wherein the tree stand is mounted permanently in the platform.

3. A platform according to claim 1 wherein the tree stand can be removably mounted on the upper surface of the platform.

4. A platform according to claim 1 wherein the storage compartment further comprises a means for holding one or more decorations in place.

5. A platform according to claim 1 wherein the lower surface of the platform has a means for supporting a center portion of the platform from sagging when a Christmas tree is positioned on the platform.

6. A platform according to claim 5 wherein the means for supporting a center portion of the platform is one or more wheels positioned near the center of the platform.

7. A platform according to claim 1 wherein the wheels are offset to prevent them hitting one another when the platform is closed.

8. A platform according to claim 1 which further comprises a means for locking the platform in the open position.

9. A platform according to claim 1 which further comprises a means for locking the platform closed.

10. A full-sized Christmas tree platform the platform positioned close to the ground comprising wheels attached directly to the platform and a means for supporting the center of the platform when a Christmas tree is placed thereon comprising one or more supporting beams.

11. A platform according to claim 10 wherein the means for supporting the center further comprises one or more wheels positioned near the center of the platform.

12. (canceled)

13. A Christmas tree platform with a means of attaching a Christmas tree stand on an upper surface of the platform.

14. A platform according to claim 4 wherein the means for holding one or more decorations in place is a tie down strap.

15. A platform according to claim 13 wherein the means for attaching the stand is at least one pair of hook and loop fasteners.
